(19) United States
(12) Patent Application Publication
(10) Pub. No.: US 2020/0242875 A1
(43) Pub. Date: Jul. 30, 2020

(54) USE OF OXIDIC MAGNETIC PARTICLES FOR MAGNETIC MARKING OF METALS

(71) Applicant: HONEYWELL INTERNATIONAL INC., Morris Plains, NJ (US)

(72) Inventor: Carsten Lau, Hannover (DE)

(73) Assignee: HONEYWELL INTERNATIONAL INC., Morris Plains, NJ (US)

(21) Appl. No.: 16/751,970

(22) Filed: Jan. 24, 2020

Related U.S. Application Data
(60) Provisional application No. 62/798,280, filed on Jan. 29, 2019.

(51) Int. Cl. G07D 5/08; H01F 1/11

(52) U.S. Cl. CPC G07D 5/08; H01F 1/11

(57) ABSTRACT

Coins or other value articles contain magnetic particles for changing the electromagnetic signature of the article and frustrate a counterfeiter's attempt to fake the article.

### TECHNICAL FIELD

The present invention generally relates to magnetic marking of metal, and more particularly relates to the use of oxidic particles for magnetic marking.

### BACKGROUND

In many applications, it is desirable to distinguish an original article from a copy or counterfeit to validate or discriminate the original article. Authenticating features can be overt or covert. Overt features are those that can be detected upon inspection, and that as a result are relatively easy for a forger to duplicate. Covert features are tougher to detect and duplicate, but they can be harder to implement. For example, metal articles such as coins can be authenticated through conductivity measurements. But for cost reasons many coins today are produced with a soft steel core plated with another metal, such as nickel or copper. The steel core generally produces a magnetic signal that masks any magnetic signal from the plated metal and makes authentication through conventional conductivity measurements difficult.

Coins and other value articles need to be recognized by vending and similar machines and either accepted or rejected. This discrimination process occurs in a coin acceptor and generally involves measuring various physical properties of the coin or article as it moves through an acceptor's mechanism.

Most coin acceptors presently in use rely on signals that result when a coin disturbs a variable electromagnetic field. For example, a coin moves between two coils acting as emitting and receiving antennae, respectively. The signal picked up by the receiving coil is then analyzed using a proprietary algorithm to produce what is called an electromagnetic signature (EMS) of the coin. Based on its EMS, the coin is either accepted or rejected.

A common problem affecting coin acceptors is the fact that electromagnetic signatures (EMSs) may be very similar for different coins. When the EMSs of coins of different denominations or coins issued in different jurisdictions are similar, there is an opportunity for fraud.

EMS sensors are widely adopted in the vending industry. In principle any change in the EMS of a coin or other value article would involve only changing a detection algorithm rather than taking a costly step of adding new sensors to the system.

Accordingly, it is desirable to provide articles and systems using them that can be readily be adapted and changed to frustrate counterfeiters. Other desirable features and characteristics will become apparent from the subsequent detailed description.

### BRIEF SUMMARY

Coins or other value articles are provided that contain magnetic particles for changing the electromagnetic signature of the article and thereby frustrate a counterfeiter's attempt to fake the article.

An authentication system for discriminating a value article is provided that includes a value article substrate; a ferrimagnetic compound disposed on or in at least a portion of the value article substrate, at least one magnetic sensor arranged to detect the magnetic properties of the ferrimagnetic compound and to produce magnetic data; and a processing unit operating under a predefined program. In operation, the processing unit inputs the magnetic data, compares the magnetic data with previously stored reference magnetic data, derives an authenticity indicator from the comparisons using pre-selected decision criteria, and communicates the authenticity indicator.

A method is provided for operating a vending machine or similar device, including any machine or device that accepts a value article such as a coin, a token, casino chip, medallion, and the like. The method comprises accepting the value article into a coin acceptor of the machine or device and measuring the electromagnetic signature (EMS) of the article. The method further involves comparing the measured EMS in a processing unit automatically to a predetermined signature. In a non-limiting embodiment, the machine returns the article to the user who inserted the article, if the EMS of the article does not match the predetermined signature.

In these methods and systems, a value article used as coin, token, medallion, casino chip is characterized as containing a value article substrate and a certain amount of a ferrimagnetic material in the form of particles disposed on or within the value article substrate. In various embodiments, the particles are present in the value article at a level of less than 2% by weight based on the weight of the value article. The presence of the particles leads to a change in the measured electromagnetic signature (EMS) of the article. Sensors in the authentication system can be programmed or re-programmed to respond to the altered EMS, thereby allowing the system to discriminate the value article. Importantly, the value article can be rejected and returned to the user if it is determined to be counterfeit. Alternatively, the article can be kept by the system for potential use as evidence of criminal activity.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

### Value Articles

These include any items that are valuable enough for there to be an issue whether an article is authentic. There is an economic incentive for unscrupulous actors to counterfeit such items as coins, casino tokens, commemorative medallions, and subway tokens, especially as the face value of the article is higher. To frustrate these, systems are put in place to detect what articles are genuine in a process known as discriminating the article.

The same concerns apply to blanks from which the value articles are manufactured. Usually the blanks contain all the metals and precious metals of the finished articles, which are prepared from the blanks in a series of stamping, embossing and other finishing steps. For this reason, value articles as used herein also includes the blanks and other intermediate structures, as well as the final product.

### Value Article Substrate

In the current teachings, magnetic particles are disposed on or in a value article substrate. The substrates take on a number of forms.

Coins and other value articles are made with a wide variety of materials. They are usually metal or alloy and are usually disc shaped. Some are bullion coins and are made of valuable metals like gold and silver. Others are used for example as money in everyday transactions, and these derive their economic value not from the value of the metals they are made of, but rather on the value placed on it by an issuing authority, be it a government or a private entity like a casino. Metals make up the substrate of the value articles.

Non-limiting examples of materials for the substrate—other than the noted gold and silver—include steel (for example austenitic steel and chrome-nickel steels), chrome-nickel alloys, copper-nickel alloys, titanium and titanium alloys, aluminum, aluminum alloys, copper, copper alloys (such as bronze and brass), zinc and zinc alloys

In various embodiments, the substrate takes the form of the entire coin or other value article. This would be the case, for example, with bullion coins made of solid gold or silver. In other embodiments, the substrate forms a disc or core that is alternatively plated with other, generally thinner layers of metal. In the alternative or in addition, the substrate is represented by the core or by the plating layers applied to such a core. Bimetallic and trimetallic articles have different metal compositions, any of which can serve as the substrate of the current teachings. For example, they can be arranged in concentric rings, exemplified by the 1-euro coin. These concentric rings also provide suitable substrates.

Particles can be incorporated or disposed in or on such value article substrates. There they function to alter the electromagnetic signature of the article and thereby enable discrimination of non-authentic articles.

### Magnetic Particles

Magnetic particles encompass a wide range of materials. Preferably, magnetic particles are selected that show or exhibit magnetic properties even after being heated to high temperatures, such as those above 1000° C. In some situations, this means the magnetic particles do not melt when heated to 1000° C. or higher for a time long enough to reach thermal equilibrium at temperatures above 1000° C. This assures the particles will survive temperatures experienced in the manufacture of the substrate, and in the finishing steps carried out on a blank. In various embodiments, oxidic materials are used because they are generally able to withstand such high temperatures. Non-limiting examples include iron oxides such as magnetite and maghemite.

Other suitable magnetic particles are drawn from garnets, magnetoplumbites, and ferrites. The term ferrite is used to indicate magnetic iron containing materials derived from iron oxides. In some embodiments, the ferrites adopt a spinel structure. In various embodiments, they are ceramic compounds containing a major amount of iron oxides and minor amounts of other metals such as Ba. Mn, Ni, and Zn. In various embodiments, the particles are ferrimagnetic particles. The use of ferrimagnetic oxides has the advantage that they are stable against oxidation and are not expected to be dissolved under acid treatment, as would be expected with metallic particles. Furthermore, they can be prepared by solid state techniques and prepared or milled to the required particle size distribution.

Advantageously, some oxides can be tailored by changing their composition while keeping the structure intact. To illustrate, an yttrium iron garnet can be altered by exchanging some yttrium (Y) for gadolinium (Gd) to get e.g. Y₃ Fe₅O₁₂, Y₂Gd Fe₅O₁₂, YGd₂ Fe₅O₁₂, and Gd₃ Fe₅O₁₂. This will also change the magnetic properties along with the magnetic moments of the ions, and a lot of variants are possible in the general field of ferrimagnetic materials by applying the different structural types and the possibilities to exchange the ions therein.

In various embodiments, the magnetic particles are selected from garnets. Especially in a garnet material, one can alter the composition of the magnetic particles by varying the rare earth ions not only to change the magnetic properties, but also to add a forensic level of security. To illustrate, if one exchanges Y³⁺ for Lu³⁺ one expects no real change in magnetic properties because the ions carry no magnetic moment. However, the chemical difference would be detectable, say by elemental analysis or other chemical or physical means. Also, ions of the group consisting of Gd³⁺, Tb³⁺ and Dy³⁺ are so close in magnetic properties that one would not expect them to be distinguishable by measuring the EMS of a coin doped with one or another of the group. Another group like this consists of the ions Tm³⁺ and Yb³⁺.

### Compositions

Magnetic particles are incorporated into the article substrates to provide a change in EMS to enable discrimination of the value articles. In one aspect, the amount of magnetic particle is determined empirically by formulating a composition and checking experimentally whether it will give a sufficient difference in electromagnetic signature. In certain embodiments, the amount of magnetic particle is limited to less than 2% by weight or less than 1% by weight, based on the weight of the value article. A minimum amount is 100 ppm or about 0.1% by weight, depending on the magnetic moment of the magnetic particle. By way of illustration, about 0.1% (which is 1000 ppm) is reasonable as a minimum for a material like yttrium iron garnet (YIG). But other garnets and magnetoplumbites have a higher magnetic moment than YIG and so can possibly be used at lower levels, such as 100 ppm and higher. Generally, lower levels are preferred because, while higher levels are likely to give more favorable EMS differences, still other factors must be considered. For example, the magnetic materials tend not to be highly conductive, so lower amounts help the overall operation of the discrimination mechanism. The structural and chemical integrity of the coin or other article also needs to be considered. Even the appearance of a coin could change at too high a loading, and chemical resistance will tend to be lowered if too high a loading introduces defects in the substrate structure. For all these reasons, it has surprisingly been found that loadings of magnetic particles below 2% by weight are favorable in these circumstances.

### Particle Size

The particle size of the magnetic particles can vary within a fairly wide range, for example the median diameter of the particles can range from 0.5 micron to 100 microns. In certain embodiments, it is preferred to have a median particle diameter of 50 microns or less, of 20 microns or less, of 10 microns or less, or 5 microns or less. Particularly preferred are median particle sizes of 0.5 to 3 microns. These particle sizes can be determined by laser diffraction particle size analyzers as commercially available from various suppliers. In various embodiments, ultrasound energy is used to pre-treat the samples to measure primary particle size. Alternatively, the particles can have a size distribution wherein the maximum diameter is 20 micron or less. Certain techniques for making the value articles are enabled if the particle size is on the low side. For example, the magnetic particles should have a dimension (such as a diameter of a mostly spherical) that is smaller than the thickness of a metal layer into which the particles are to be incorporated. Smaller particles (for example those with a distribution wherein the median diameter or the maximum diameter is less than 20 microns) can be more readily surrounded by the metal of the substrate, giving the article a structure more resistant to wear and chemical attack.

Small particle sizes (e.g. particles having a median particle size less than 5 μm) have the additional advantage that they allow for a more homogeneous distribution and so would be more difficult to detect and analyze for a counterfeiter. Applying particles having the particularly preferred median particle size of 0.5 to 3 microns leads to a very homogeneous distribution and therefore also to a very homogeneous response signal when probed across (the surface) of a substrate.

### Manufacturing Techniques

One way of making the value articles is to provide a composition containing two kinds of particles, one being of the substrate metal and the other of the magnetic particles. In a preferred embodiment, the magnetic particles are present in the composition at less than 2% by weight based on the total weight of the particles. In a powder metallurgy process, the composition containing the two materials is sintered to make a blank that can be later be processed to the final article.

Another method involves incorporating magnetic particles into a layer that is being plated onto an existing substrate such as a core of a coin blank. In other techniques, a harder magnetic oxide particle can be driven into a softer metal substrate. Here, the oxide can be predisposed on the soft metal of a substrate and the magnetic particle (e.g. an oxidic material described herein) pushed in to the substrate by rolling or striking. In another embodiment, the magnetic particle can be provided between two layers of metal and a cladded structure is made by rolling. In another embodiment, the magnetic oxide particles are provided in a (precisely loaded, combustible, soft plastic) film that is laid on a metal sheet; in a rolling process the particles are pressed into the metal. In another embodiment, the particles can be printed onto the metal and then rolled or struck in; this can be carried out continuously on the sheet before it is rolled or on the coin blank by pad printing or stamping before it is struck.

### Methods and Systems

According to the current teachings, the authenticity of a value article—a coin, token, medallion, etc.—is determined by a comparison of magnetic data to pre-determined reference magnetic data. These properties may be evaluated to the same time and place or may be evaluated at different times depending upon the system. The authentication system of the present invention includes at least one magnetic sensor arranged to detect magnetic properties of the magnetic particles and to produce magnetic data. These sensors produce signals that may be amplified by low noise electronics to a sufficient level such that they can be converted to digital values for processing. Suitable magnetic sensors include any magnetometer or other device that has the required magnetic responses as determined by one skilled in the art.

One or more processing units, such as a computer, may be used to store the reference data and collect, correlate, and discriminate test data. For instance, the one or more processing unit operates under a predefined program wherein the processing unit reads or inputs the test magnetic data of a single value article, compares the test magnetic data with previously stored reference magnetic data and derives an authenticity indicator from the comparison results using a pre-selected decision criterion. The output unit, which may or may not be part of the processing unit, then communicates the authenticity indicator so as to indicate authentication or lack of authentication of the test value article.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A value article comprising a substrate with incorporated magnetic particles, wherein the magnetic articles are present at less than 2% by total weight of the substrate.

2. The value article according to claim 1, wherein the magnetic particles are oxidic.

3. The value article according to claim 1, wherein the magnetic particles show magnetic properties after being heated to 1000° C.

4. The value article according to claim 3, wherein the magnetic particles are selected from garnets, magnetoplumbites, and ferrites.

5. The value article according to claim 1, wherein the magnetic particles are ferrimagnetic.

6. The value article according to claim 1, wherein the substrate is the entire value article.

7. The value article according to claim 1, wherein the substrate is a core of the value article.

8. The value article according to claim 1, wherein the substrate is a metallic layer plated on a core.

9. The value article according to claim 1, wherein the value article is a coin.

10. An authentication system for discriminating a value coin, comprising:
a) a value coin substrate;
b) a magnetic compound disposed on or in at least a portion of the value coin substrate, wherein the magnetic particles are present at less than 2% by weight based on the total weight of particles and substrate,
c) at least one magnetic sensor arranged to detect the magnetic properties of the magnetic compound and to produce magnetic data; and
d) a processing unit operating under a predefined program wherein the processing unit inputs the magnetic data, compares the magnetic data with previously stored reference magnetic data, derives an authenticity indicator from the comparisons using pre-selected decision criteria, and communicates the authenticity indicator thereby indicating authentication or lack of authentication of the value document.

11. The system according to claim 10, wherein the magnetic compound is oxidic.

12. The system according to claim 10, wherein the magnetic compound is present on the substrate at less than 2% by weight based on the total weight of the substrate and magnetic compound.

13. The system according to claim 10, wherein the magnetic compound is one that maintains magnetic properties after being heated to 1000° C.

14. The system according to claim 10, wherein the magnetic particles are selected from garnets, magnetoplumbites, and ferrites.

15. The system according to claim 1, wherein the magnetic particles are ferrimagnetic.

16. The system according to claim 6, wherein the particles have a size distribution characterized by a median diameter of less than 20 microns

17. The system according to claim 6, wherein the particles have a size distribution characterized by a median diameter of less than 10 microns.

18. The system according to claim 6, wherein the particles have a size distribution characterized by a maximum diameter of less than 20 microns.

19. The value article of claim 1, wherein the magnetic particles comprise a garnet.
